(19) United States
(12) Patent Application Publication
(10) Pub. No.: US 2013/0209769 A1
(43) Pub. Date: Aug. 15, 2013

(54) CORONA RESISTANT STRUCTURES AND METHODS RELATING THERETO

(71) Applicants: Jeffrey Michael BARTOLIN, Westerville, OH (US); Thomas Edward CARNEY, Orient, OH (US); Meredith L. DUNBAR, Canal Winchester, OH (US)

(72) Inventors: Jeffrey Michael BARTOLIN, Westerville, OH (US); Thomas Edward CARNEY, Orient, OH (US); Meredith L. DUNBAR, Canal Winchester, OH (US)

(73) Assignee: E I DU PONT DE NEMOURS AND COMPANY, Wilmington, DE (US)

(21) Appl. No.: 13/370,019

(22) Filed: Feb. 9, 2012

(51) Int. Cl. B32B 27/08; B32B 27/20

(52) U.S. Cl. 428/220; 428/325

(57) ABSTRACT

The present disclosure is directed to a corona resistant structure having a polyimide layer. The polyimide layer is composed of a chemically converted polyimide and a corona resistant composite filler. The chemically converted polyimide is derived from at least 50 mole percent of an aromatic dianhydride and at least 50 mole percent of an aromatic diamine. The corona resistant composite filler has an organic component and an inorganic ceramic oxide component. The weight ratio of the organic component to the inorganic ceramic oxide component is from 0.01 to 1.0. At least a portion of the organic component comprises an organo-siloxane moiety or an organo-metaloxane moiety.

### FIELD OF DISCLOSURE

The present disclosure relates generally to corona resistant structure. More specifically, the present disclosure relates generally to corona resistant structures useful for high voltage and corona resistant applications.

### BACKGROUND OF THE DISCLOSURE

Corona resistant films used as wire insulation need to have good electrical properties (e.g., dielectric strength), as well as good mechanical properties. Typically, a wire will be bent into various shapes or directions. The corona resistant film covering the wire or cable needs to have the ability to do the same. Thus modulus, tensile strength and elongation are important properties in addition to dielectric strength in wire wrap applications. Conventional corona resistant films fail to provide the desired compactness, with the high mechanical strength. The addition of filler can negatively impact mechanical properties. The film can become more brittle (lower tensile strength and elongation).

A need exists for a corona resistant film having improved dielectric strength, tensile strength and elongation and corona resistance.

### SUMMARY

The present disclosure is directed to a corona resistant structure comprising:

A. a polyimide layer comprising:
i) a chemically converted polyimide in an amount from 50 to 95 weight percent based upon total weight of the polyimide layer, the chemically converted polyimide being derived from:
   a) at least 50 mole percent of an aromatic dianhydride, based upon a total dianhydride content of the chemically converted polyimide, and
   b) at least 50 mole percent of an aromatic diamine based upon a total diamine content of the chemically converted polyimide;
ii) a corona resistant composite filler:
   a) present in an amount from 5 to 25 weight percent, based upon total weight of the polyimide layer,
   b) having a median particle size from 0.1 to 5 microns,
   c) having an organic component and an inorganic ceramic oxide component, wherein a weight ratio of the organic component to the inorganic ceramic oxide component is from 0.01 to 1.0; wherein at least a portion of the organic component comprises an organo-siloxane moiety or an organo-metaloxane moiety; and

wherein the polyimide layer has a thickness from 8 to 55 microns.

In another embodiment, the present disclosure is directed to a corona resistant structure comprising:

A. a polyimide layer comprising:
i) a chemically converted polyimide in an amount from 50 to 95 weight percent based upon total weight of the polyimide layer, the chemically converted polyimide being derived from:
   a) at least 50 mole percent of an aromatic dianhydride, based upon a total dianhydride content of the chemically converted polyimide, and
   b) at least 50 mole percent of an aromatic diamine based upon a total diamine content of the chemically converted polyimide;
ii) a corona resistant composite filler:
   a) present in an amount from 10 to 25 weight percent, based upon total weight of the polyimide layer,
   b) having a median particle size from 0.1 to 5 microns,
   c) having an organic component and an inorganic ceramic oxide component, wherein a weight ratio of the organic component to the inorganic ceramic oxide component is from 0.01 to 1.0; wherein at least a portion of the organic component comprises an organo-siloxane moiety or an organo-metaloxane moiety; and wherein the polyimide layer has a thickness from 8 to 55 microns; and

B. a fluoropolymer layer comprising tetrafluoroethylene hexafluoropropylene copolymer in an amount from 65 to 100 weight percent based on the total weight of the fluoropolymer layer and the fluoropolymer layer is in direct contact with and on at least one side of the polyimide layer.

In another embodiment, the present disclosure is directed to a corona resistant structure comprising:

A. a polyimide layer comprising:
ii) a chemically converted polyimide in an amount from 50 to 95 weight percent based upon total weight of the polyimide layer, the chemically converted polyimide being derived from:
   a) 100 mole percent pyromellitic dianhydride; and
   b) 100 mole percent 4,4′-diaminodiphenyl ether;
ii) a corona resistant composite filler:
   a) present in an amount from 5 to 25 weight percent, based upon total weight of the polyimide layer,
   b) having a median particle size from 0.1 to 5 microns,
   c) having an octyl silane component and a fumed alumina component, wherein a weight ratio of the octyl silane component to the fumed alumina component is from 0.01 to 1.0; wherein; and

wherein the polyimide layer has a thickness from 8 to 55 microns.

### BRIEF DESCRIPTION OF THE DRAWING

FIG. 1 is a transmission electron micrograph of a cross section of one filled layer of a three layer thermally converted polyimide film where the two outer layers are filled and the core layer is unfilled. The filled layer shown in the micrograph contains 20 weight percent fumed alumina.

FIG. 2 is a transmission electron micrograph of a cross section of a single layer chemically converted PMDA/4,4-ODA with 13 weight percent fumed alumina.

### DETAILED DESCRIPTION OF THE PREFERRED EMBODIMENT(S)

### Definitions

“Film” is intended to mean a free-standing film or a (self-supporting or non self-supporting) coating. The term “film” is used interchangeably with the term “layer and refers to covering a desired area.

“Dianhydride” as used herein is intended to include precursors or derivatives thereof, which may not technically be a dianhydride but would nevertheless functionally equivalent due to the capability of reacting with a diamine to form a polyamic acid which in turn could be converted into a polyimide.

“Diamine” as used herein is intended to include precursors or derivatives thereof, which may not technically be diamines but are nevertheless functionally equivalent due to the capability of reacting with a dianhydride to form a polyamic acid which in turn could be converted into a polyimide.

“Polyamic acid” as used herein is intended to include any polyimide precursor material derived from a combination of dianhydride and diamine monomers or functional equivalents thereof and capable of conversion to a polyimide.

“Chemical conversion” or “chemically converted” as used herein denotes the use of a catalyst (accelerator) or a dehydrating agent (or both) to convert a polyamic acid to a polyimide and is intended to include a partially chemically converted polyimide which is then dried at elevated temperatures to a solids level greater than 98%.

“Conversion chemicals” or “imidization chemicals” as used herein denotes a catalyst (accelerator) capable of converting a polyamic acid to a polyimide and/or a dehydrating agent capable of converting a polyamic acid to a polyimide.

“Finishing” herein denotes adding a dianyhdride in a polar aprotic solvent which is added to a prepolymer solution to increase the molecular weight and viscosity. The dianhydride used is typically the same dianhydride used (or one of the same dianhydrides when more than one is used) to make the prepolymer.

In describing certain polymers it should be understood that sometimes applicants are referring to the polymers by the monomers used to make them or the amounts of the monomers used to make them. While such a description may not include the specific nomenclature used to describe the final polymer or may not contain product-by-process terminology, any such reference to monomers and amounts should be interpreted to mean that the polymer is made from those monomers, unless the context indicates or implies otherwise.

As used herein, the terms “comprises,” “comprising,” “includes,” “including,” “has,” “having” or any other variation thereof, are intended to cover a non-exclusive inclusion. For example, a method, process, article, or apparatus that comprises a list of elements is not necessarily limited to only those elements but may include other elements not expressly listed or inherent to such method, process, article, or apparatus. Further, unless expressly stated to the contrary, “or refers to an inclusive or and not to an exclusive or. For example, a condition A or B is satisfied by any one of the following: A is true (or present) and B is false (or not present), A is false (or not present) and B is true (or present), and both A and B are true (or present).

Also, articles “a” or “an” are employed to describe elements and components of the invention. This is done merely for convenience and to give a general sense of the invention. This description should be read to include one or at least one and the singular also includes the plural unless it is obvious that it is meant otherwise.

### Overview

The corona resistant structure of the present disclosure has a polyimide layer. The polyimide layer comprises a chemically converted polyimide and a corona resistant composite filler. A polyimide layer having a chemically converted polyimide has a more uniform dispersion of corona resistant composite filler compared to a polyimide layer having thermally converted polyimide. Additionally, the polyimide layer having a chemically converted polyimide has better dielectric strength, tensile strength, elongation and corona resistance compared to a polyimide layer having a thermally converted polyimide.

### Chemically Converted Polyimide

The chemically converted polyimide is made by the step of mixing a polyamic acid solution with a catalyst and/or a dehydrating agent capable of converting a polyamic acid to a polyimide. U.S. Pat. No. 5,166,308 to Kreuz et al. discloses a chemically converted aromatic copolyimide film with a modulus of elasticity of 600 to 1200 Kpsi, a coefficient of thermal expansion of 5 to 25 ppm/° C., a coefficient of hygroscopic expansion of 2 to 30 ppm/% RH, a water absorption of less than 3.0% at 100% RH and an etch rate greater than the same copolyimide film prepared by a thermal conversion process using the same time and temperature conditions. However, Kreuz et al. does not disclose the addition of filler to the polyimide film.

The gel film that is produced by a chemical conversion process is self supporting in spite of its high solvent content. It was believed with the gel film having so much liquid which needs to be removed, that any filler would migrate with the removal of the large amount of liquids or even be carried out of the film with the solvent. If the filler in the polyimide gel film did migrate with the removal of solvent, the film would have the tendency to curl. It was believed that chemical conversion would not produce a filled polyimide film with a uniform dispersion sufficient to maintain properties over the entire film. Thus, Kreuz et al. does not contemplate the use of any amount of filler.

The thinner the polyimide film, the more difficult it is to fill without the film becoming brittle. To overcome this problem, a three layer film is typically made. The two outer layers being filled and the inner (core) layer being unfilled or containing less than 5 weight percent of filler. The core layer allows the multilayer film to maintain acceptable mechanical properties. When chemical conversion is used, a single layer filled polyimide film can be produced and still maintain good properties and can be made thinner than if thermal conversion was used. In some embodiments, the polyimide layer has a thickness between and including any two of the following: 5, 10, 15, 20, 25, 30, 35, 40, 45, 50 and 55 microns. In some embodiments, the polyimide layer has a thickness from 5 to 55 microns. In some embodiments, the polyimide layer has a thickness between 8 and 55 micron. In yet another embodiment, the polyimide layer has a thickness from 5 to 30 microns.

In some embodiments the chemically converted polyimide is present in an amount between and including any two of the following: 50, 55, 60, 65, 70, 75, 80, 85, and 95 weight percent based on the total weight of the polyimide layer. In some embodiments, the chemically converted polyimide is present in an amount from 50 to 95 weight percent based on the total weight of the polyimide layer. The chemically converted polyimide is derived from:
a) at least 50 mole percent of an aromatic dianhydride, based upon a total dianhydride content of the chemically converted polyimide, and
b) at least 50 mole percent of an aromatic diamine based upon a total diamine content of the chemically converted polyimide.

In some embodiments, the aromatic dianhydride is selected from the group consisting of:
pyromellitic dianhydride (PMDA);
3,3′,4,4′-biphenyl tetracarboxylic dianhydride (BPDA);
3,3′,4,4′-benzophenone tetracarboxylic dianhydride (BTDA);
4,4′-oxydiphthalic anhydride;
3,3′,4,4′-diphenyl sulfone tetracarboxylic dianhydride;
2,2-bis(3,4-dicarboxyphenyl)hexafluoropropane;
Bisphenol A dianhydride; and mixtures thereof.

In another embodiment, the aromatic dianhydride is selected from the group consisting of:
2,3,6,7-naphthalene tetracarboxylic dianhydride;
1,2,5,6-naphthalene tetracarboxylic dianhydride;
2,2′,3,3′-biphenyl tetracarboxylic dianhydride;
2,2-bis(3,4-dicarboxyphenyl)propane dianhydride;
bis(3,4-dicarboxyphenyl)sulfone dianhydride;
3,4,9,10-perylene tetracarboxylic dianhydride;
1,1-bis(2,3-dicarboxyphenyl)ethane dianhydride;
1,1-bis(3,4-dicarboxyphenyl)ethane dianhydride;
bis(2,3-dicarboxyphenyl)methane dianhydride;
bis(3,4-dicarboxyphenyl)methane dianhydride;
oxydiphthalic dianhydride;
bis(3,4-dicarboxyphenyl)sulfone dianhydride; and
mixtures thereof.

In some embodiments, the chemically converted polyimide may contain up to and including 50 weight percent of an aliphatic dianhydride. Examples of suitable aliphatic dianhydrides include: cyclobutane dianhydride; [1S*,5R*,6S*]-3-oxabicyclo[3.2.1]octane-2,4-dione-6-spiro-3(tetrahydrofuran-2,5-dione) and mixtures thereof.

In some embodiments, the aromatic diamine is selected from the group consisting of:
3,4′-oxydianiline (3,4′-ODA);
1,3-bis-(4-aminophenoxy)benzene;
4,4′-diaminodiphenyl ether (4,4′-ODA);
1,4-diaminobenzene; (PPD)
1,3-diaminobenzene;
2,2′-bis(trifluoromethyl)benzidene;
4,4′-diaminobiphenyl;
4,4′-diaminodiphenyl sulfide;
9,9′-bis(4-amino)fluorine; and
mixtures thereof.

In another embodiment, the aromatic diamine is selected from a group consisting of:
4,4′-diaminodiphenyl propane;
4,4′-dianiino diphenyl methane;
benzidine;
3,3′-dichlorobenzidine;
3,3′-diamino diphenyl sulfone;
4,4′-diamino diphenyl sulfone;
1,5-diamino naphthalene;
4,4′-diamino diphenyl diethylsilane;
4,4′-diamino diphenysilane;
4,4′-diamino diphenyl ethyl phosphine oxide;
4,4′-diamino diphenyl N-methyl amine;
4,4′-diamino diphenyl N-phenyl amine;
1,4-diaminobenzene(p-phenylene diamine);
1,2-diaminobenzene; and
mixtures thereof.

In some embodiments, the chemically converted polyimide may contain up to and including 50 weight percent of an aliphatic dianhydride. Examples of suitable aliphatic diamines include: hexamethylene diamine, dodecane diamine, cyclohexane diamine; and mixtures thereof.

In some embodiments, the chemically converted polyimide is derived from 100 mole percent pyromellitic dianhydride and 100 mole percent 4,4′-diaminodiphenyl ether.

In some embodiments, the chemically converted polyimide is made by the step of mixing a polyamic acid solution with a catalyst or a dehydrating agent capable of converting a polyamic acid to a polyimide. In another embodiment, the chemically converted polyimide is made by the step of mixing a polyamic acid solution with a catalyst and a dehydrating agent capable of converting a polyamic acid to a polyimide. In a chemical conversion process, the polyamic acid solution is either immersed in or mixed with conversion (imidization) chemicals. In one embodiment, the conversion chemicals are tertiary amine catalysts (accelerators) and anhydride dehydrating agents. In one embodiment, the anhydride dehydrating material is acetic anhydride, which is often used in molar excess relative to the amount of amic acid (amide acid) groups in the polyamic acid, typically about 1.2 to 2.4 moles per equivalent of polyamic acid. In one embodiment, a comparable amount of tertiary amine catalyst is used.

Alternatives to acetic anhydride as the anhydride dehydrating material include: i. other aliphatic anhydrides, such as, propionic, butyric, valeric, and mixtures thereof; ii. anhydrides of aromatic monocarboxylic acids; iii. Mixtures of aliphatic and aromatic anhydrides; iv. carbodimides; and v. aliphatic ketenes (ketenes may be regarded as anhydrides of carboxylic acids derived from drastic dehydration of the acids).

In one embodiment, the tertiary amine catalysts are pyridine and beta-picoline and are typically used in amounts similar to the moles of anhydride dehydrating material. Lower or higher amounts may be used depending on the desired conversion rate and the catalyst used. Tertiary amines having approximately the same activity as the pyridine, and beta-picoline may also be used. These include alpha picoline; 3,4-lutidine, 3,5-lutidine; 4-methyl pyridine; 4-isopropyl pyridine; N,N-dimethylbenzyl amine; isoquinoline; 4-benzyl pyridine, N,N-dimethyldodecyl amine, triethyl amine, and the like. A variety of other catalysts for imidization are known in the art, such as imidazoles, and may be useful in accordance with the present disclosure.

The conversion chemicals can generally react at about room temperature or above to convert polyamic acid to polyimide. In one embodiment, the chemical conversion reaction occurs at temperatures from 15° C. to 120° C. with the reaction being very rapid at the higher temperatures and relatively slower at the lower temperatures.

In one embodiment, the chemically treated polyamic acid solution can be cast or extruded onto a heated conversion surface or substrate. In one embodiment, the chemically treated polyamic acid solution can be cast on to a belt or drum. The solvent can be evaporated from the solution, and the polyamic acid can be partially chemically converted to polyimide. The resulting solution then takes the form of a polyamic acid-polyimide gel. Alternately, the polyamic acid solution can be extruded into a bath of conversion chemicals consisting of an anhydride component (dehydrating agent), a tertiary amine component (catalyst) or both with or without a diluting solvent. In either case, a gel film is formed and the percent conversion of amic acid groups to imide groups in the gel film depends on contact time and temperature but is usually about 10 to 75 percent complete. For curing to a solids level greater than 98%, the gel film typically must be dried at elevated temperature (from about 200° C., up to about 550° C.), which will tend to drive the imidization to completion.

The gel film tends to be self-supporting in spite of its high solvent content. Typically, the gel film is subsequently dried to remove the water, residual solvent, and remaining conversion chemicals, and in the process the polyamic acid is essentially completely converted to polyimide (i.e., greater than 98% imidized). The drying can be conducted at relatively mild conditions without complete conversion of polyamic acid to polyimide at that time, or the drying and conversion can be conducted at the same time using higher temperatures.

Because the gel film has so much liquid that must be removed during the drying and converting steps, the gel film generally must be restrained during drying to avoid undesired shrinkage and may be stretched by as much as 150 percent of its initial dimension. In film manufacture, stretching can be in either the longitudinal direction or the transverse direction or both. If desired, restraint can also be adjusted to permit some limited degree of shrinkage. The gel film can be held at the edges, such as in a tenter frame, using tenter clips or pins for restraint.

High temperatures can be used for short times to dry the gel film and induce further imidization to convert the gel film to a polyimide film in the same step. In one embodiment, the polyimide film is heated to a temperature of 200° C. to 550° C. Generally, less heat and time are required for thin films than for thicker films.

### Corona Resistant Composite Filler

The polyimide layer of the present disclosure comprises a corona resistant composite filler. The corona resistant composite filler comprises having an organic component and an inorganic ceramic oxide component, wherein a weight ratio of the organic component to the inorganic ceramic oxide component is from 0.01 to 1.0. In some embodiments, the weight ratio of the organic component to the inorganic ceramic oxide component is 0.01, 0.05, 0.1, 0.2, 0.3, 0.4, 0.5, 0.6, 0.7, 0.8, 0.9 or 1.0. At least a portion of the organic component comprises an organo-siloxane moiety or an organo-metaloxane moiety (e.g., organozirconate, organotitanate, organoalurninate).

In some embodiments, the inorganic ceramic oxide component is silica, alumina, titania, and/or zirconia. In some embodiments, the inorganic ceramic oxide component comprises silica and/or alumina. In some embodiments, the inorganic ceramic oxide component is fumed alumina. In some embodiments, the organic component of the corona resistant composite filler material is chosen primarily to provide or improve dispersability of the corona resistant composite filler material into a particular solvated polymer matrix or polymer matrix precursor. In some embodiments, the organic component of the corona resistant composite filler material is chosen to reduce the moisture absorption on the inorganic ceramic oxide component. Ordinary skill and experimentation may be necessary in optimizing the organic component for any particular solvent system selected. In some embodiments, the organo-siloxane moiety is octyl silane. In some embodiments, the corona resistant filler is an inorganic ceramic oxide without an organic component. In another embodiment, the organic component is a coating on the inorganic ceramic oxide component. The organic component may or may not cover the entire surface of the inorganic ceramic oxide component.

In some embodiments, the corona resistant composite filler is present in an amount between and including any to of the following numbers: 5, 10, 15, 20 and 25 weight percent, based upon the total weight of the polyimide layer. In some embodiments, the corona resistant composite filler is present in an amount from 5 to 25 weight percent, based upon the total weight of the polyimide layer. In another embodiment, the corona resistant composite filler is present in an amount from 5 to 20 weight percent, based upon the total weight of the polyimide layer.

In some embodiments, the corona resistant composite filler has a median particle size from 0.1 to 5 microns, wherein at least 80, 85, 90, 92, 94, 95, 96, 98, 99 or 100 percent of the dispersed corona resistant composite filler is within the above defined size range. Median particle size was measured using a Horiba LA-930 particle size analyzer (Horiba Instruments, Inc., Irvine, Calif.), DMAC was used as the carrier fluid. In some embodiments, the corona resistant composite filler is a nanofiller. The term nanofiller is intended to mean a filler with at least one dimension less than 1000 nm, i.e., less than 1 micron.

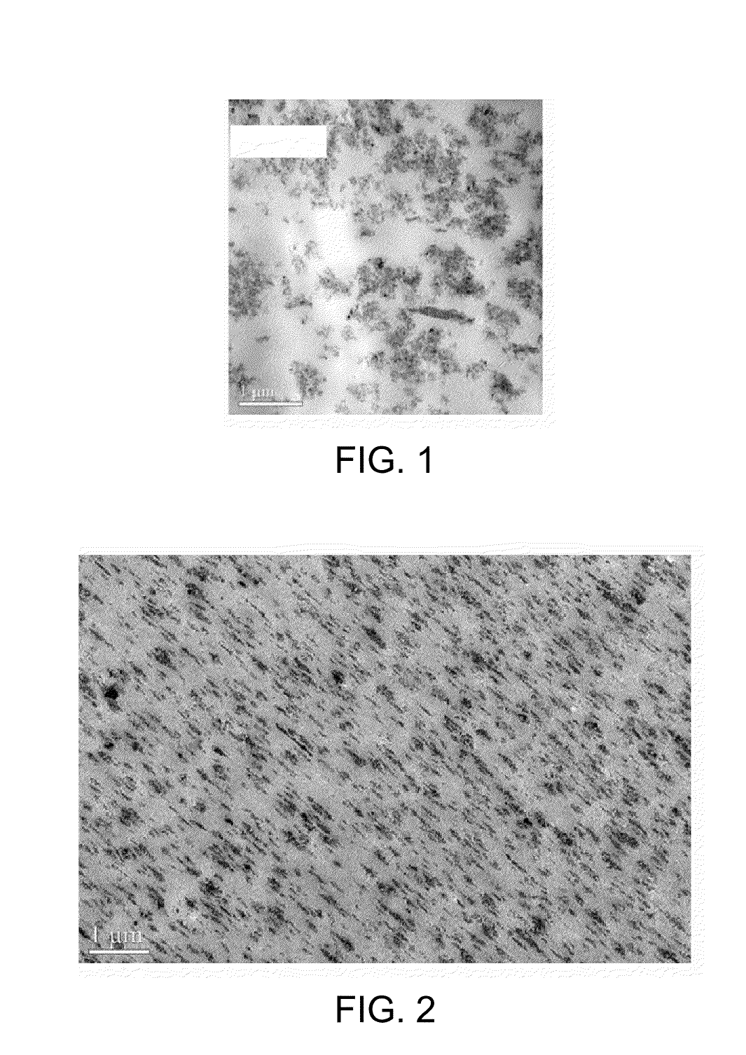

Inorganic ceramic oxide fillers can be difficult to efficiently and economically disperse into a polyimide in sufficient quantities to achieve optimal desired corona resistance. An ineffective dispersion of corona resistant composite filler can result in inadequate corona resistance and/or diminished mechanical properties. It has been surprisingly found that chemical conversion not only produces a polyimide layer with a more uniform dispersion of corona resistant composite filler but also tends to improve mechanical properties such as tensile strength and elongation as well as increase or maintain corona resistance and dielectric strength. It is unexpected that a chemically converted polyimide film is not as brittle as polyimide film prepared by thermal conversion with the same filler loading. FIG. 1 is a transmission electron micrograph of a cross section of one filled layer of a three layer thermally converted polyimide film where the two outer layers are filled and the core layer is unfilled. The filled layer shown in the micrograph contains 20 weight percent filler, Kapton®100CR, available from E. I. du Pont de Nemours and Company, Wilmington, Del. FIG. 2 is a transmission electron micrograph of a cross section of a single layer chemically converted PMDA/4,4-ODA with 13 weight percent fumed alumina illustrating a more uniform dispersion than the polyimide film produced by thermal conversion shown in FIG. 1.

In some embodiments, the polyimide layer of the present disclosure additionally comprises a dispersing agent. In some embodiments, the polyimide layer of the present disclosure additionally comprises a dispersing agent in an amount from 1 to 100 weight percent based on the weight of the inorganic ceramic oxide component. In some embodiments, the dispersing agent is selected from the group consisting of phosphated polyethers, phosphated polyesters, and mixtures thereof. In another embodiment, the dispersing agent is an alkylolammonium salt of a polyglycol ester. In another embodiment, the dispersing agent is selected from the group consisting of Disperbyk 180, a alkylolammonium salt of a polyglycol ester, Disperbyk 111, a phosphated polyester, Byk W-9010, a phosphated polyester or mixtures there of (all available from Byk-Chemie, GmBH, Wesel, Germany). In another embodiment, the dispersing agent is Solplus D540, a phosphated ethylene oxide/propylene oxide copolymer available from Lubrizol, Inc., Cleveland, Ohio. In yet another embodiment, the dispersing agent is a mixture of any of the above dispersing agents. In some embodiments, the dispersing agent is an aromatic polyamic acid or aromatic polyimide. In another embodiment the dispersing agent is a polyalkylene ether such as polytetramethylene glycol and polyethylene glycol. Typically, aromatic polyamic acid or aromatic polyimide have high temperature stability and thus mostly would remain in the chemically converted polyimide. Whereas, dispersing agents such as polyalkylene ethers have a low temperature stability and would mostly be burned off at the temperatures used in the imidization process.

### Polyimide Layer Formation

In some embodiments, the polyimide can be prepared by making a corona resistant composite filler slurry. The slurry may or may not be milled using a ball mill to reach the desired particle size. The slurry may or may not be filtered to remove any residual large particles. A polyamic acid solution can be made by methods well known in the art. The polyamic acid solution may or may not be filtered. In some embodiments, the solution is mixed in a high shear mixer with the corona resistant composite filler slurry. When a polyamic acid solution is made with a slight excess of diamine, additional dianhydride solution may or may not be added to increase the viscosity of the mixture to the desired level for film casting. The amount of the polyaniic acid solution and the corona resistant composite filler slurry can be adjusted to achieve the desired loading levels in the cured polyimide layer. In some embodiments, the mixture is cooled below 0° C. and mixed with a catalyst capable of converting a polyamic acid to a polyimide, dehydrating agent capable of converting a polyamic acid to a polyimide or both prior to casting. The polyamic acid solution containing catalyst and/or dehydrating agent can be cast or extruded onto a heated conversion surface. In one embodiment, the heated conversion surface is a rotating drum or belt. The solvent can be evaporated from the solution, and the polyamic acid can be partially chemically converted to polyimide. The resulting solution then takes the form of a polyamic acid-polyimide gel. Alternately, the polyamic acid solution can be extruded into a bath of conversion chemicals consisting of a dehydrating agent, a catalyst or both with or without a diluting solvent. In either case, a gel film is formed and the percent conversion of amic acid groups to imide groups in the gel film depends on contact time and temperature but is usually about 10 to 75 percent complete. The gel film tends to be self-supporting in spite of its high solvent content. Because the gel film has so much liquid that must be removed during the drying and converting steps, the gel film generally must be restrained during drying to avoid undesired shrinkage and may be stretched by as much as 150 percent of its initial dimension. In film manufacture, stretching can he in either the longitudinal direction or the transverse direction or both. If desired, restraint can also be adjusted to permit some limited degree of shrinkage, The gel film can be held at the edges, such as in a tenter frame, using tenter clips or pins for restraint.

For curing to a solids level greater than 98%, the gel film typically must be dried at elevated temperature (from about 200° C., up to about 550° C.), which will tend to drive the imidization to completion. Generally, less heat and time are required for thin films than for thicker films.

In one embodiment, examples of suitable solvents include: formamide solvents (N,N-dimethylformamide, N,N-diethylformamide, etc.), acetamide solvents (N,N-dimethylacetamide, N,N-diethylacetamide, etc.), pyrrolidone solvents (N-methyl-2-pyrrolidone, N-vinyl-2-pyrrolidone, etc.), phenol solvents (phenol, o-, m- or p-cresol, xylenol, halogenated phenols, catechol, etc.), hexamethylphosphoramide and gamma-butyrolactone. It is desirable to use one of these solvents or mixtures thereof. It is also possible to use combinations of these solvents with aromatic hydrocarbons such as xylene and toluene, or ether containing solvents like diglyme, propylene glycol methyl ether, propylene glycol, methyl ether acetate, tetrahydrofuran, and the like.

Increasing the molecular weight (and solution viscosity) of the prepolymer can be accomplished by adding incremental amounts of additional dianhydride (or additional diamine, in the case where the dianhydride monomer is originally in excess in the prepolymer) in order to approach a 1:1 stoichiometric ratio of dianhydride to diamine.

The corona resistant composite filler (dispersion or colloid thereof) can be added at several points in the polyimide layer preparation. In one embodiment, the colloid or dispersion is incorporated into a prepolymer having a Brookfield solution viscosity in the range of about 50-100 poise at 25° C. “Prepolymer” is intended to mean a lower molecular weight polymer, typically made with a small stoichiometric excess (about 24%) of diamine monomer (or excess dianhydride monomer). In an alternative embodiment, the colloid or dispersion can be combined with the monomers directly, and in this case, polymerization occurs with the filler present during the reaction. In another embodiment, the colloid or dispersion can be combined with the “finished”, high viscosity polyimide. The monomers may have an excess of either monomer (diamine or dianhydride) during this “in situ” polymerization. The monomers may also be added in a 1:1 ratio. In the case where the monomers are added with either the amine (case i) or the dianhydride (case ii) in excess, increasing the molecular weight (and solution viscosity) can be accomplished, if necessary, by adding incremental amounts of additional dianhydride (case i) or diamine (case ii) to approach the 1:1 stoichiometric ratio of dianhydride to amine.

### Corona Resistant Structure

In one embodiment, the corona resistant structure comprises a polyimide layer, the polyimide layer comprising:
i) a chemically converted polyimide in an amount from 50 to 95 weight percent based upon total weight of the polyimide layer, the chemically converted polyimide being derived from:
   a) at least 50 mole percent of an aromatic dianhydride, based upon a total dianhydride content of the chemically converted polyimide, and
   b) at least 50 mole percent of an aromatic diamine based upon a total diamine content of the chemically converted polyimide;
ii) a corona resistant composite filler;
   a) present in an amount from 5 to 25 weight percent, based upon total weight of the polyimide layer,
   b) having a median particle size from 0.1 to 5 microns,
   c) having an organic component and an inorganic ceramic oxide component, wherein a weight ratio of the organic component to the inorganic ceramic oxide component is from 0.01 to 1.0; wherein at least a portion of the organic component comprises an organo-siloxane moiety or an organo-metaloxane moiety; and

wherein the polyimide layer has a thickness from 8 to 55 microns.

In another embodiment, the corona resistant structure comprises a polyimide layer, the polyimide layer comprising:
i) a chemically converted polyimide in an amount from 50 to 95 weight percent based upon total weight of the polyimide layer, the chemically converted polyimide being derived from:
   a) 100 mole percent pyromellitic dianhydride and
   b) 100 mole percent 4,4′-diaminodiphenyl ether;
ii) a corona resistant composite filler:
   a) present in an amount from 5 to 25 weight percent, based upon total weight of the polyimide layer,
   b) having a median particle size from 0.1 to 5 microns,
   c) having an octyl silane component and a fumed alumina component, wherein a weight ratio of the octyl silane component to the fumed alumina component is from 0.01 to 1.0;

and wherein the polyimide layer has a thickness from 8 to 55 microns.

In yet another embodiment, the corona resistant structure comprises:

A. a polyimide layer comprising:
i) a chemically converted polyimide in an amount from 50 to 95 weight percent based upon total weight of the polyimide layer, the chemically converted polyimide being derived from:
   a) at least 50 mole percent of an aromatic dianhydride, based upon a total dianhydride content of the chemically converted polyimide, and
   b) at least 50 mole percent of an aromatic diamine based upon a total diamine content of the chemically converted polyimide;
ii) a corona resistant composite filler:
   a) present in an amount from 10 to 25 weight percent, based upon total weight of the polyimide layer,
   b) having a median particle size from 0.1 to 5 microns,
   c) having an organic component and an inorganic ceramic oxide component, wherein a weight ratio of the organic component to the inorganic ceramic oxide component is from 0.01 to 1.0, wherein at least a portion of the organic component comprises an organo-siloxane moiety or an organo-metaloxane moiety; and

wherein the polyimide layer has a thickness from 8 to 55 microns; and

B. a fluoropolymer layer comprising tetrafluoroethylene hexafluoropropylene copolymer in an amount from 65 to 100 weight percent based on the total weight of the fluoropolymer layer and the fluoropolymer layer is in direct contact with, and on at least one side of, the polyimide layer.

In another embodiment, the corona resistant structure has a fluoropolymer layer on both sides of the polyimide layer and in direct contact with the polyimide layer. The fluoropolymer layer is used to bond the polyimide layer to a metal layer or wire (typically copper wire). The fluoropolymer layer also is used to bond the polyimide layer to itself when more than one layer of the corona resistant structure is used.

The fluoropolymer layer comprises tetrafluoroethylene hexafluoropropylene copolymer in an amount from 65 to 100 weight percent based on the total weight of the fluoropolymer layer and the fluoropolymer layer is in direct contact with, and on at least one side of, the polyimide layer. In one embodiment, the fluoropolymer layer comprises tetrafluoroethylene-hexafluoropropylene copolymer in an amount between (and optionally including) any two of the following numbers: 65, 70, 75, 80, 85, 90, 95 and 100 weight percent based on the total weight of the fluoropolymer layer and the fluoropolymer layer is in direct contact with, and on at least one side of, the polyimide layer. In one embodiment, the fluoropolymer layer comprises 100 weight percent tetrafluoroethylene-hexafluoropropylene copolymer.

The fluoropolymer layer will generally have a thickness in a range between (and optionally including) any two of the following numbers: 0.25, 0.3, 0.4, 0.5, 0.6, 0.7, 0.8, 0.9, 1.0, 1.25, 1.5, 1.75, 2, 3, 4, 5, 10, 11, 12, 13, 14, 15, 16, 17, 18, 19, 20, 21, 22, 23, 24 and 25 microns. A useful thickness range is oftentimes in a range from about 0.75 microns to 2.5 microns (generally in the range of about 0.03 to about 0.10 mils). In practice, the desired thickness can depend upon the specifications, particularly for military or commercial aircraft applications.

In some embodiments, the fluoropolymer layer may be applied to the polyimide layer by, but not limited to, solution coating, colloidal dispersion coating or lamination.

The polyimide layer may have its surface modified to improve adhesion to other layers, such as the fluoropolymer layer. Examples of useful surface modification is, but are not limited to, corona treatment, plasma treatment under atmospheric pressure, plasma treatment under reduced pressure, treatment with coupling agents like silanes and titanates, sandblasting, alkali-treatment, and acid-treatment.

In some embodiments, the corona resistant structure additionally comprises an outer fluoropolymer layer in direct contact with the fluoropolymer layer and wherein the outer fluoropolymer is a blend of tetrafluoroethylene -hexafluoropropylene copolymer and perfluoro alkoxy resin, a blend of tetrafluoroethylene -hexafluoropropylene copolymer and polytetrafluoroethylene or a blend of tetrafluoroethylene hexafluoropropylene copolymer and perfluoro alkoxy resin and polytetrafluoroethylene.

In some embodiments, the corona resistant structure is made up of the following layers in order:
i) polyimide layer comprising a chemically converted polyimide,
ii) fluoropolymer layer comprising tetrafluoroethylene hexafluoropropylene copolymer, and
iii) outer fluoropolymer layer.

The fluoropolymer layer of the present disclosure may comprise flame retardants and thermally conductive fillers, as well as fillers to tailor opacity, color and the rheology of the fluoropolymer. layer.

In some embodiments, the corona resistant structure is useful as a wire wrap. The wire wrap may optionally contain additional layers such as but not limited to, adhesive layers or scrap abrasion resistant layers. Films or sheets of wire wrap can be slit into narrow widths to provide tapes. These tapes can then be wound around an electrical conductor in spiral fashion or in an overlapped fashion. The amount of overlap can vary, depending upon the angle of the wrap. The tension employed during the wrapping operation can also vary widely, ranging from just enough tension to prevent wrinkling, to a tension high enough to stretch and neck down the tape. Even when the tension is low, a snug wrap is possible since the tape will often shrink under the influence of heat during any ensuing heat-sealing operation. Heat-sealing of the tape can be accomplished by treating the tape-wrapped conductor at a temperature and time sufficient to fuse the bonding layer to the other layers in the composite. The heat-sealing temperature required ranges generally from 240, 250, 275, 300, 325 or 350° C. to 375, 400, 425, 450, 475 or 500° C., depending upon the insulation thickness, the gauge of the metal conductor, the speed of the production line and the length of the sealing.

### EXAMPLES

The invention will be further described in the following examples, which are not intended to limit the scope of the invention described in the claims.

Kapton®100CR is a 1 mil (25.4 micron) three layer thermally converted polyimide film with the two outer layers filled and the core layer unfilled. The outer layers each contain 20 weight percent fumed alumina. Available from E. I. du Pont de Nemours and Company, Wilmington, Del.

Dielectric strength was measured with a Beckmann Industrial AC Dielectric Breakdown Tester, according to ASTM D149. The average of 3-5 individual measurements was recorded.

Tensile properties were measured according to ASTM 0-882-91, Method A. Specimen size was 25 mm×150 mm; jaw separation 100 mm; jaw speed 50 mm/min.

Corona resistance was measured according to ASTM 02275-89 and IEC-343, at 1200 or 1250 VAC and 1050 Hz, The film sample was placed on a flat plate electrode. Nine cylindrical electrodes were mounted in an array in contact with the top side of the film. A conductive silver paste was applied to the bottom side of the test film, in contact with the flat plate electrode, in the area underneath each cylindrical electrode. All 9 electrodes were run simultaneously, and the elapsed time for the 5^{th} electrode to fail was recorded. Lab #1 used electrodes of ¼ inch diameter. The film sample and electrodes were enclosed in a cabinet that was purged with dry (<20% relative humidity) aft for the duration of the test. Lab #2 used electrodes of ½ inch diameter. The film sample and electrodes were exposed to ambient lab humidity conditions during the Lab #2 test. Lab #2 also did not apply silver paste to the film. All testing was done at room temperature.

Ash content of film was determined by heating a weighed film sample in a furnace at 900 C., in order to burn off all of the organic material, leaving only the inorganic component behind, Comparing weights before and after heating gives the percent ash. The average of 2 samples was recorded.

Polyamic acid viscosity measurements were made on a Brookfield Programmable DV-II+ viscometer using either a RV/HA/HB #7 spindle or a LV #5 spindle. The viscometer speed was varied from 5 to 100 rpm to provide and acceptable torque value. Readings were temperature corrected to 25° C.

### Example 1

### (Single Layer Chemically Converted Polyimide Film Containing 13% Fumed Alumina)

Example 1 demonstrates that chemical conversion achieves better dielectric strength, mechanical properties and corona resistance when compare to thermal conversion.

A fumed alumina slurry was prepared, consisting of 77.1 wt % DMAC, 11.9 wt % octyl silane treated fumed alumina (approximately 10 parts octyltrimethoxysilane per 100 parts of alumina), 1.2 wt % Disperbyk 180 dispersant, and 9.8 wt % polyamic acid prepolymer solution of BPDA/PMDA//PPD/4,4′-ODA, 92/8/19515 (14.5 wt % polyamic acids solids in DMAC). The ingredients were thoroughly mixed using a high shear blade-type disperser. The polyamic acid solution was added last. The slurry was then processed in a media mill to disperse any large agglomerates and to achieve the desired particle size. The median particle size of the milled slurry was 0.23 microns.

The PMDA/4,4′ODA prepolymer solution (20.6% polyamic acid solids, approximately 50 Poise viscosity) was “finished” by mixing in a high shear mixer with a 5.8 wt % PMDA solution in DMAC, in order to increase molecular weight and viscosity to approximately 2500 Poise. A metered stream of the finished polyamic acid solution was cooled to approximately −8° C. Similarly cooled metered streams of acetic anhydride 0.15 g/g polyamic acid solution) and 3-picoline (0.15 g/g polyamic acid solution), along with a metered stream of fumed alumina slurry (0.13 g/g polyamic acid solution), were mixed with a high shear mixer into the polyamic acid solution. The cooled mixture was filtered and immediately cast into a film, using a slot die, onto a 95° C. hot, rotating drum. The resulting self-supporting gel film was stripped off the drum and fed into a tenter oven, where it was dried and cured to a solids level greater than 98%, using convective and radiant heating. The MD and TD stretch were adjusted in the tenter oven to roughly balance the mechanical properties of the cured film. Based on ash analysis, the film contained 13 wt % fumed alumina. The film is 1 mil (25.4 microns) thick.

Results are shown in table 1.

### Example 2

### (Single Layer Chemically Converted Polyimide Film Containing 9% Fumed Alumina)

A fumed alumina slurry was prepared, consisting of 65.5 wt % DMAC, 17.0 wt % octyl silane treated fumed alumina (approximately 10 parts octyltrimethoxysilane per 100 parts of alumina), 3.4 wt % Disperbyk 180 dispersant, and 14.1 wt % polyamic acid prepolymer solution of BPDA/PMDA//PPD/4,4′-ODA, 92/8//95/5 (14,5 wt % polyamic acids solids in DMAC). The ingredients were thoroughly mixed using a high shear blade-type disperser. The polyamic acid solution was added last. The slurry was then processed in a media mill to disperse any large agglomerates and to achieve the desired particle size. The median particle size of the milled slurry was 0.35 microns.

The PMDA/4,4′ODA prepolymer solution (20.6% polyamic acid solids, approximately 50 Poise viscosity) was “finished” by mixing in a high shear mixer with a 5.8 wt % PMDA solution in DMAC, in order to increase molecular weight and viscosity to approximately 2500 Poise. A metered stream of the finished polyamic acid solution was cooled to approximately −8° C. Similarly cooled metered streams of acetic anhydride 0.15 g/g polyamic acid solution) and 3-picoline (0.15 g/g polyamic acid solution), along with a metered stream of fumed alumina slurry (0.13 g/g polyamic acid solution), were mixed with a high shear mixer into the polyamic acid solution. The cooled mixture was filtered and immediately cast into a film, using a slot die, onto a 105° C. hot, rotating drum. The resulting self-supporting gel film was stripped off the drum and fed into a tenter oven, where it was dried and cured to a solids level greater than 98%, using convective and radiant heating. The MD and TD stretch were adjusted in the tenter oven to roughly balance the mechanical properties of the cured film. Based on ash analysis, the film contained 9.2 wt % fumed alumina. The film is 0.96 mil (24.4 microns) thick.

Results are shown in table 1.

### Comparative Example 1

### (Kapton®100CR)

Comparative Example 1 demonstrates a three layer thermally converted film has lower dielectric strength, mechanical properties and corona resistance compared to the chemically converted film of Example 1.

Results are shown in table 1.

### Comparative Example 2

### (Single Layer Thermally Imidized Film Containing 13% Fumed Alumina)

Comparative Example 2 demonstrates that a single layer thermally converted film has lower dielectric strength, mechanical properties and corona resistance compared to the chemically converted film of Example 1.

A fumed alumina slurry was prepared as in Example 1. The slurry was mixed with a PMDA/4,4′ODA prepolymer solution (20.6% polyamic acid solids, approximately 50 Poise viscosity) in a rotor-stator, high speed dispersion mill, in an amount to give 13 wt % alumina, on a cured film basis. A small amount of a belt release agent (which enables the cast green film to be stripped from the casting belt) was also mixed in.

The slurry/prepolymer mixture was “finished” by mixing in a high shear mixer with 5.8 wt PMDA solution in DMAC, in order to increase molecular weight and viscosity to approximately 1150 Poise. The finished polymer/slurry mixture was filtered and metered through a slot die onto a moving polished stainless steel belt. The belt was passed into a convective oven, to evaporate solvent and partially imidize the polymer, to produce a “green” film. Green film solids (as measured by weight loss upon heating to 400° C.) was 66.7%. The green film was stripped off the casting belt and wound up. The green film was then passed through a tenter oven to produce a cured polyimide film. During tentering, shrinkage was controlled by constraining the film along the edges. The film appeared brittle, and was prone to tearing along the edges where it was constrained in the tenter oven. Based on ash analysis, the film contained 13 wt % fumed alumina. The film is 0.93 mil (23,6 microns) thick.

TABLE 1

| | | | | Comp. ex. 2 |
|---|---|---|---|---|
| | | | Comp. | Single layer |
| | | | ex. 1 | thermally |
| Test | Example 1 | Example 2 | 100CR | converted |
| Dielectric strength 60 Hz | | | | |
| (kV/mm) | 303 | 296 | 287 | 249 |
| (V/mil) | 7700 | 7531 | 7300 | 6333 |
| Machine direction tensile | | | | |
| strength | | | | |
| (Mpa) | 230 | 206 | 172 | 140.7 |
| (kpsi) | 33.4 | 29.9 | 24.9 | 20.4 |
| Transverse direction | | | | |
| tensile strength | | | | |
| (MPa) | 241 | 217 | 151 | 119.3 |
| (kpsi) | 35.0 | 31.5 | 21.9 | 17.3 |
| Machine direction | 81 | 50 | 63 | 36.5 |
| elongation (%) | | | | |
| Transverse direction | 74 | 50 | 68 | 38 |
| elongation (%) | | | | |
| Corona resistance lab 1 | 17 | 2.2 | 13.8 | 0.75 (Ave |
| 1250 VAC@ 1050 Hz | | | | of 2 runs) |
| (hours) | | | | |
| Corona resistance lab 2 | 20.3 | 1.8 | 12.0 | |
| 1200 VAC@ 1050 Hz | | | | |
| (hours) | | | | |

Note that not all of the activities described above in the general description or the examples are required, that a portion of a specific activity may not be required, and that further activities may be performed in addition to those described. Still further, the order in which each of the activities are listed are not necessarily the order in which they are performed. After reading this specification, skilled artisans will be capable of determining what activities can be used for their specific needs or desires.

In the foregoing specification, the invention has been described with reference to specific embodiments. However, one of ordinary skill in the art appreciates that various modifications and changes can be made without departing from the scope of the invention as set forth in the claims below. Accordingly, the specification and any figures are to be regarded in an illustrative rather than a restrictive sense and all such modifications are intended to be included within the scope of the invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

When an amount, concentration, or other value or parameter is given as either a range, preferred range or a list of upper values and lower values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

What is claimed is:

1. A corona resistant structure comprising:
A. a polyimide layer comprising:
i) a chemically converted polyimide in an amount from 50 to 95 weight percent based upon total weight of the polyimide layer, the chemically converted polyimide being derived from:
a) at least 50 mole percent of an aromatic dianhydride, based upon a total dianhydride content of the chemically converted polyimide, and
b) at least 50 mole percent of an aromatic diamine based upon a total diamine content of the chemically converted polyimide;
ii) a corona resistant composite filler:
a) present in an amount from 5 to 25 weight percent, based upon total weight of the polyimide layer,
b) having a median particle size from 0.1 to 5 microns,
c) having an organic component and an inorganic ceramic oxide component, wherein a weight ratio of the organic component to the inorganic ceramic oxide component is from 0.01 to 1.0, wherein at least a portion of the organic component comprises an organo-siloxane moiety or an organo-metaloxane moiety; and
wherein the polyimide layer has a thickness from 8 to 55 microns.

2. The corona resistant structure in accordance with claim 1 wherein:
a. the aromatic dianhydride is selected from the group consisting of:
pyromellitic dianhydride,
3,3′,4,4′-biphenyl tetracarboxylic dianhydride,
3,3′,4,4′-benzophenone tetracarboxylic dianhydride;
4,4″-oxydiphthalic anhydride,
3,3′,4,4′-diphenyl sulfone tetracarboxylic dianhydride,
2,2-bis(3,4-dicarboxyphenyl)hexafluoropropane,
Bisphenol A dianhydride; and
mixtures thereof; and
b. the aromatic diamine is selected from the roup consisting of:
3,4′-oxydianiline,
1,3-bis-(4-aminophenoxy)benzene,
4,4′-diaminodiphenyl ether,
1,4-diaminobenzene,
1,3-diaminobenzene,
2,2′-bis(trifluoromethyl)benzidene,
4,4′-diaminobiphenyl,
4,4′-diaminodiphenyl sulfide,
9,9′-bis(4-amino)fluorine and
mixtures thereof.

3. The corona resistant structure in accordance with claim 1 wherein the chemically converted polyimide is derived from
a) 100 mole percent pyromellitic dianhydride; and
b) 100 mole percent 4,4′-diaminodiphenyl ether.

4. The corona resistant structure in accordance with claim 1 wherein the inorganic ceramic oxide component is fumed alumina.

5. The corona resistant structure in accordance with claim 1 wherein the polyimide layer additionally comprises a dispersing agent in an amount from 1 to 100 weight percent based on the weight of the inorganic ceramic oxide component.

6. The corona resistant structure in accordance with claim 5 wherein the dispersing agent is selected from the group consisting of phosphated polyethers, phosphated polyesters and mixtures thereof.

7. The corona resistant structure in accordance with claim 5 wherein the dispersing agent is an alkylolammonium salt of a polyglycol ester.

8. The corona resistant structure in accordance with claim 1 wherein the organo-siloxane moiety is octyl silane.

9. A corona resistant structure comprising:
A. a polyimide layer comprising:
i) a chemically converted polyimide in an amount from 50 to 95 weight percent based upon total weight of the polyimide layer, the chemically converted polyimide being derived from:
a) at least 50 mole percent of an aromatic dianhydride, based upon a total dianhydride content of the chemically converted polyimide, and
b) at least 50 mole percent of an aromatic diamine based upon a total diamine content of the chemically converted polyimide;
ii) a corona resistant composite filler:
a) present in an amount from 10 to 25 weight percent, based upon total weight of the polyimide layer,
b) having a median particle size from 0.1 to 5 microns,
c) having an organic component and a inorganic ceramic oxide component, wherein a weight ratio of the organic component to the inorganic ceramic oxide component is from 0.01 to 1.0, wherein at least a portion of the organic component comprises an organo-siloxane moiety or an organo-metaloxane moiety; and
wherein the polyimide layer has a thickness from 8 to 55 microns; and
B. a fluoropolymer layer comprising tetrafluoroethylene hexafluoropropylene copolymer in an amount from $5 to 100 weight percent based on the total weight of the fluoropolymer layer and the fluoropolymer layer is in direct contact with and on at least one side of the polyimide layer.

10. The corona resistant structure in accordance with claim 9 additionally comprising an outer fluoropolymer layer in direct contact with the fluoropolymer layer and wherein the outer fluoropolymer layer is a blend of tetrafluoroethylene hexafluoropropylene copolymer and perfluoro alkoxy resin, a blend of tetrafluoroethylene hexafluoropropylene copolymer and polytetrafluoroethylene or a blend of tetrafluoroethylene-hexafluoropropylene copolymer and perfluoro alkoxy resin and polytetrafluoroethylene.

11. The corona resistant structure in accordance with claim 9 wherein:
a. the aromatic dianhydride is selected from the group consisting of:
pyromellitic dianhydride,
3,3′,4,4′-biphenyl tetracarboxylic dianhydride,
3,3′,4,4′-benzophenone tetracarboxylic dianhydride;
4,4′-oxydiphthalic anhydride,
3,3′,4,4′-diphenyl sulfone tetracarboxylic dianhydride,
2,2-bis(3,4-dicarboxyphenyl)hexafluoropropane,
Bisphenol A dianhydride, and
mixtures thereof; and
b. the aromatic diamine is selected from the group consisting of:
3,4′-oxydianiline,
1,3-bis-(4-aminophenoxy)benzene,
4,4′-diaminodiphenyl ether,
1,4-diaminobenzene,
1,3-diaminobenzene,
2,2′-bis(trifluoromethyl) benzidene,
4,4′-diaminobiphenyl,
4,4′-diaminodiphenyl sulfide,
9,9′-bis(4-amino)fluorine and
mixtures thereof.

12. The corona resistant structure in accordance with claim 9 wherein the chemically converted polyimide is derived from
a) 100 mole percent pyromellitic dianhydride; and
b) 100 mole percent 4,4′-diaminodiphenyl ether.

13. The corona resistant structure in accordance with claim 9 wherein the inorganic ceramic oxide component is fumed alumina,

14. The corona resistant structure in accordance with claim 9 wherein the polyimide layer additionally comprises a dispersing agent in an amount from 1 to 100 weight percent based on the weight of the inorganic ceramic oxide component.

15. The corona resistant structure in accordance with claim 14 wherein the dispersing agent is selected from the group consisting of phosphated polyethers, phosphated polyesters and mixtures thereof.

16. The corona resistant structure in accordance with claim 14 wherein the dispersing agent is an alkylolammonium salt of a polyglycol ester.

17. The corona resistant structure in accordance with claim 9 wherein the organo-siloxane moiety is octyl silane.

18. A corona resistant structure comprising:
A. a polyimide layer comprising:
ii) a chemically converted polyimide in an amount from 50 to 95 weight percent based upon total weight of the polyimide layer, the chemically converted polyimide being derived from:
a) 100 mole percent pyromellitic dianhydride; and
100 mole percent 4,4′-diaminodiphenyl ether;
ii) a corona resistant composite filler:
a) present in an amount from 5 to 25 weight percent, based upon total weight of the polyimide layer,
b) having a median particle size from 0.1 to 5 microns,
c) having an octyl silane component and a fumed alumina component, wherein a weight ratio of the octyl silane component to the fumed alumina component is from 0.01 to 1.0 wherein; and
wherein the polyimide layer has a thickness from 8 to 55 microns.
